(19) United States
(12) Patent Application Publication
(10) Pub. No.: US 2026/0208980 A1
(43) Pub. Date: Jul. 23, 2026

(54) OBJECT MOVING DEVICE

(71) Applicant: I.M.A. INDUSTRIA MACCHINE AUTOMATICHE S.P.A., OZZANO DELL'EMILIA (BO) (IT)

(72) Inventors: Claudio TREBBI, OZZANO DELL'EMILIA (BO) (IT); Alessandro FARNE', OZZANO DELL'EMILIA (BO) (IT); Gianluca ZAULI, OZZANO DELL'EMILIA (BO) (IT); Daniele RICCIARDI, OZZANO DELL'EMILIA (BO) (IT); Filippo MEARINI, OZZANO DELL'EMILIA (BO) (IT); Sergio MANERA, OZZANO DELL'EMILIA (BO) (IT); Annalisa MALFATTO, OZZANO DELL'EMILIA (BO) (IT)

(21) Appl. No.: 19/143,646

(22) PCT Filed: Dec. 12, 2023
(86) PCT No.: PCT/IT2023/050277

§ 371 Date: Jun. 26, 2025

(30) Foreign Application Priority Data
Dec. 28, 2022 (IT) 102022000026913

(51) Int. Cl. B65G 54/02

(52) U.S. Cl. CPC B65G 54/02; B65G 2201/0235; B65G 2207/26

(57) ABSTRACT

Moving device (10) for moving objects (C) filled with a product (P) on a base plane (101) having a driving surface (102) and provided with electric energizing means (103) configured to selectively generate one or more magnetic fields. The moving device (10) comprising a transport member (11) provided with magnetic means (15) configured to generate a respective magnetic field capable of interacting with the magnetic fields of said energizing means (103) to cause said transport member (11) to contactless slide on the driving surface (102), and a support member (16) configured to support the objects (C) when the transport member (11) slides on the driving surface (102).

### FIELD OF THE INVENTION

The present invention concerns a moving device for moving objects, in particular containers of small sizes, for example vials, phials or flasks, fillable with fluid, solid, powder, or gel products. By way of example, the moving device can be used in machines and/or apparatuses for the pharmaceutical, cosmetic, healthcare, chemical and/or food fields.

### BACKGROUND OF THE INVENTION

In the industrial sector of preparing chemical, cosmetic and/or pharmaceutical products, various machines and/or apparatuses are known in which electromagnetic moving, or transport, devices are used to move objects, such as containers, to and from one or more work stations, for example to fill them, close them and then package them.

In particular, by means of such devices, the movement of the objects occurs with an electromagnetic type drive, without constraint in direction or fixed path, and without generation of particulate caused by rubbing, for example using technology known as “planar motors”.

Such planar motors comprise respective magnetic means which cooperate with electric energizing means operatively associated with them and configured to selectively generate one or more magnetic fields capable of influencing and interacting with the magnetic means.

In particular, such magnetic means are mounted on, or in, the moving device, and the electric energizing means, such as coils, are incorporated within a fixed reference, or driving, surface of a base plane of the apparatus, on which the moving device can move without contact thanks to the controlled electromagnetic field that is generated between the magnetic means and the electric energizing means.

Moreover, the planar motors are very versatile, since they allow to follow both rectilinear as well as curved trajectories and paths with respect to the reference surface, suitably commanding the electric energizing means.

Object moving devices are known from documents WO 2018/176137 A1, US 2017/225814 A1, and US 2022/227008 A1.

However, the aforementioned magnetic fields can also influence the objects that are moved by the moving device, in particular certain types of products that may be present therein.

In this regard, the magnetic fields can directly influence and/or interact with certain types of products, causing morphological or functional responses that result in biological or health effects. By biological effect we mean an effect that occurs as a result of an interaction that causes detectable physiological variations in the product, but which the latter can normally compensate. In particular, the only effects established on a scientific basis are the so-called acute effects, that is, those that occur in a short interval of time whenever the level of exposure to electromagnetic waves exceeds a certain threshold. Therefore, the relevant biological effect at the lowest level of exposure is, consequently, a scientific criterion for defining the exposure limits of the product present inside the objects, in order to protect it from the aforementioned acute effects.

Normally, in these known apparatuses the moving devices move within a controlled atmosphere chamber which is associated at the upper part with the base plane and in which there are generated unidirectional or laminar flows of filtered air, or turbulent flows of filtered air substantially parallel to the base plane.

These flows of filtered air have the function of allowing the recirculation of air and reducing the risk of contaminating the objects, since possible contaminating agents, such as contaminating particles or dusts, are dragged along the direction of the air flow and the objects present on the moving devices undergo a continuous washing of clean air. For example, in the event that the objects are open containers with a certain product inside them, the air flows have the function of acting directly on the mouth of the containers to prevent contaminating particles from entering, or falling, inside them.

However, the action of such air flows can also lead to unwanted indirect effects; for example, since the containers are substantially very close to the base plane, there can be the disadvantage that the air flows also interact with the latter and that this interaction causes small amounts of particles and/or dusts that may be present on it to rise, with the risk that they fall inside the objects or the product present therein.

Therefore, the Applicant has carried out numerous studies to overcome the problems and shortcomings of the state of the art, in order to perfect a device for moving objects in which the latter, or the product present therein, are not influenced or altered by the aforementioned magnetic fields.

### SUMMARY OF THE INVENTION

The present invention is set forth and characterized in the independent claim. The dependent claims describe other characteristics of the present invention or variants to the main inventive idea.

In accordance with the above purpose, also achieving considerable advantages compared to the state of the prior art, the present invention provides a moving device according to the present invention for moving objects filled with a product on a base plane having a driving surface, and provided with electric energizing means configured to selectively generate one or more magnetic fields. The moving device comprises a transport member provided with magnetic means configured to generate a respective magnetic field capable of interacting with the magnetic fields of the electric energizing means to cause the transport member to contactless slide on the driving surface, and a support member configured to support the objects when the transport member slides on the driving surface.

In accordance with one aspect of the present invention, the moving device further comprises one or more shielding elements placed on the moving device in such a manner as to be positioned interposed between an upper surface of the transport member and the objects, when these are supported by the support member.

In particular, the shielding elements are configured to limit and/or diminish the effect of electromagnetic phenomena caused by the interaction between the electric energizing means and the magnetic means.

In accordance with another aspect, the support member comprises at least one base member placed on the upper surface and having a supporting portion departing from the base member, and a housing portion provided with one or more housing seatings configured to accommodate the objects in a raised position.

In accordance with another aspect, the supporting portion is slidingly mounted on the at least one base member so as to vary a minimum distance from the upper surface.

In accordance with another aspect, the one or more shielding elements are made of a metal material with high magnetic permeability.

In accordance with another aspect of the present invention, the one or more shielding elements are directly associated with the upper surface or, alternatively, the one or more shielding elements are directly associated with the support member.

The present invention also concerns an apparatus comprising a base plane provided with a driving surface which is provided with electric energizing means configured to selectively generate one or more magnetic fields, a work chamber housing the base plane and in which air flows are generated. In particular, the apparatus comprises one or more moving devices as described above, which are operatively associated with the base plane and are mobile in the work chamber.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a three-dimensional view of an object moving device according to the present invention, which is placed in an apparatus for packaging such objects;

FIG. 2 is a front view of the moving device of FIG. 1;

FIG. 3 is a lateral view of the moving device of FIG. 1;

FIG. 4 is a lateral view like that of FIG. 3 which shows another embodiment of the moving device;

FIGS. 5 and 6 are lateral views of the moving device of FIG. 4 according to further variants;

FIG. 7 is a lateral and schematic view of an apparatus comprising one or more moving devices of FIG. 1.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

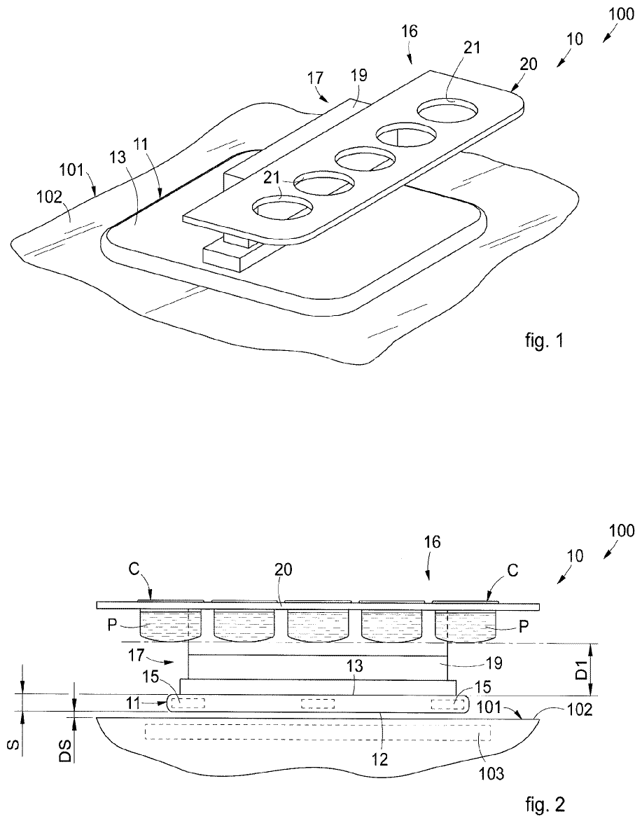

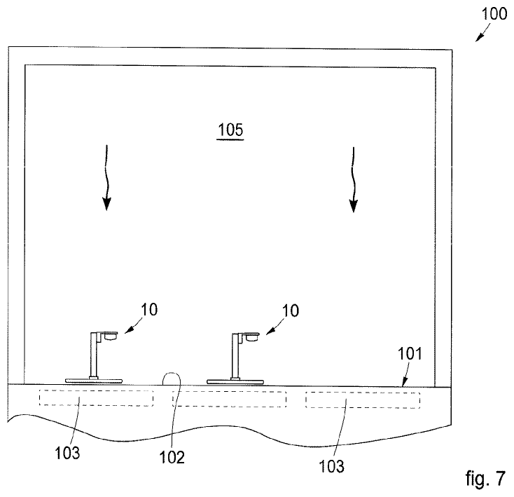

With reference to FIG. 1, a moving device 10 according to the present invention is arranged and usable for moving objects C, for example to and from one or more work stations of an apparatus 100 (FIG. 7).

In the example given here, the objects C can be, without limitation to generality, phials, vials, flasks, or other types of containers with a small mass and sizes, capable of containing one or more fluid products P, in particular liquids, solids, that is, in powder form, or gels.

The apparatus 100 comprises a base plane 101 having a reference surface, hereafter defined as driving surface 102, below which electric energizing means 103 (FIGS. from 2 to 6), of a known type, are associated or provided, which are configured to selectively generate one or more low-frequency magnetic fields, even locally distributed, along the movement path of the objects C. For example, the electric energizing means 103 comprise a plurality of electric coils or windings which, during use, are connected to an electric energy supply network having suitable electric voltage and current values.

We must clarify that the expression “driving surface” is defined as such because it is a surface on which the drive of the moving devices 10 takes place through the interaction with the electric energizing means 103.

The apparatus 100 can further comprise a work chamber 105 (FIG. 7). The work chamber 105 is preferably with a controlled atmosphere, associated at the upper part with the base plane 101 and in which the moving devices 10 are mobile and operative. In particular, flows of filtered air, as described above, are provided and/or generated inside the work chamber 105, able to limit contamination in the same work chamber 105 and, in particular, of the product(s) P present in the objects C, subjecting them to a continuous washing of filtered and clean air.

Specifically, the aforementioned air flows, schematized with arrows in FIG. 7, have the function of acting on an open upper end of the objects C to prevent any contaminating particles from entering it, thus contaminating the product present therein.

The moving device 10 comprises a base transport member 11 (FIG. 1) substantially having a square shape and a certain thickness S. The transport member 11 comprises a flat lower surface 12 (FIGS. from 2 to 6), facing the driving surface 102. The moving device 10 also comprises an upper surface 13, also flat, opposite with respect to the lower surface 12 and, therefore, to the driving surface 102, which faces upward. According to possible embodiments of the present invention, the thickness S is about 10 mm.

The moving device 10 is operatively associated with the driving surface 102 and is capable of moving with respect to the latter by means of the low-frequency magnetic fields generated by the aforementioned electric energizing means.

In particular, the moving device 10 is provided with magnetic means 15, such as permanent magnets for example, which are configured to generate a respective static magnetic field capable of interacting with the low-frequency magnetic fields to cause the selective movement of the same moving device 10.

In this way, the moving device 10 can move independently with respect to the driving surface 102, remaining distanced from it by a certain raising distance DS, that is, without contacting it, advantageously with several degrees of freedom, as will be described in detail below.

By way of example, this raising distance DS can be comprised between about 0.5 mm and about 4.5 mm, so as to allow a correct interaction between the electric energizing means 103 and the magnetic means 15.

Preferably, the moving device 10 is made as the movable part of an electromagnetically driven “planar motor”, per se known in the art.

The moving device 10 is provided with support means, in the examples given here configured as a support member 16 for supporting one or more objects C at a certain minimum distance D1 from the upper surface 13, so that the objects C themselves, or their content, are not influenced by, or do not interact with, electromagnetic phenomena deriving from the magnetic fields. It should be noted that the minimum distance D1 is measured between the upper surface 13 and the lowest point of the product P inside the objects C (FIG. 1).

Specifically, by the term “electromagnetic phenomena” we mean phenomena of magnetic induction, magnetomechanical actions and electronic interactions, per se known.

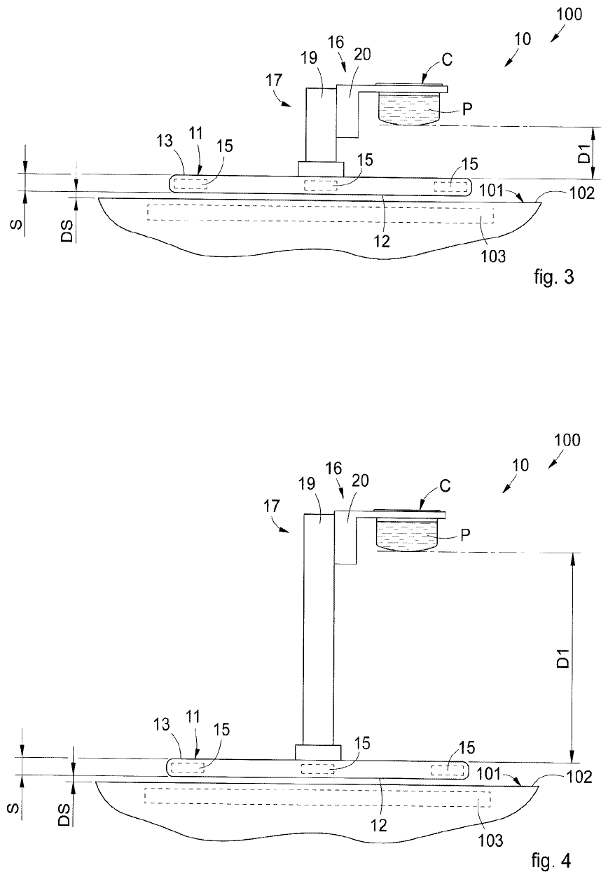

In particular, the minimum distance D1 is greater than at least twice the thickness S of the transport member 11. In particular, the minimum distance is greater than about 30 mm (FIGS. 2 and 3).

This prevents the product P present in the objects C from being subjected to one or more acute effects, as defined above, deriving from the electromagnetic phenomena. Furthermore, this minimum distance D1 advantageously allows to prevent any particles and/or dusts from rising and falling into the objects C themselves, or into the product P present therein, due to the electromagnetic turbulences that can form at the driving surface 102.

In addition, considering the actions or indirect effects of the air flows when they interact with the base plane 101, the minimum distance D1 is modified to prevent particles and/or dusts from rising and falling into the objects C themselves. In this case, the minimum distance D1 is greater than about twelve times the thickness S of the transport member 11. In particular, the minimum distance D1 is greater than approximately 120 mm (FIG. 4).

The support member 16 comprises at least one support, hereafter defined as base member 17 (FIGS. from 1 to 6) placed on the upper surface 13 and having a supporting part, or portion, 19 perpendicular to the latter, which departs from the base member 17 itself, and a housing part, or portion, 20 configured to support and house the objects C.

The housing portion 20 is provided with a plurality of housing seatings 21 (FIG. 1) configured to accommodate, that is, in which to place, respective objects C in a raised position. In this raised position, this minimum distance D1 from the upper surface 13 is guaranteed (FIGS. from 2 to 6).

In particular, the housing seatings 21 are conformed in such a way as to cooperate with only a part of the objects C, preferably the upper one, keeping them stably in an upright position and leaving at least a lower part thereof exposed.

As shown in the embodiment in FIG. 1, the objects C are defined by phials and are placed in the housing seatings 21 in such a way that a respective open upper end thereof, through which the product P is inserted and having an edge protruding with respect to the body of the object C itself, abuts with this protruding edge on the housing seating 21.

In accordance with some embodiments of the present invention, the supporting portion 19 is slidingly mounted on the base member 17, and is therefore adjustable in height so as to adapt to the desired minimum distance D1 from the upper surface 13, in particular considering the actions or indirect effects of the air flows.

It is clear that in order to carry out a correct movement of the objects C, considering the shape of the base member 17 and the very position of the objects C themselves on the moving device 10, the objects C have to be placed in such a way as to not exceed a certain maximum distance from the upper surface 13.

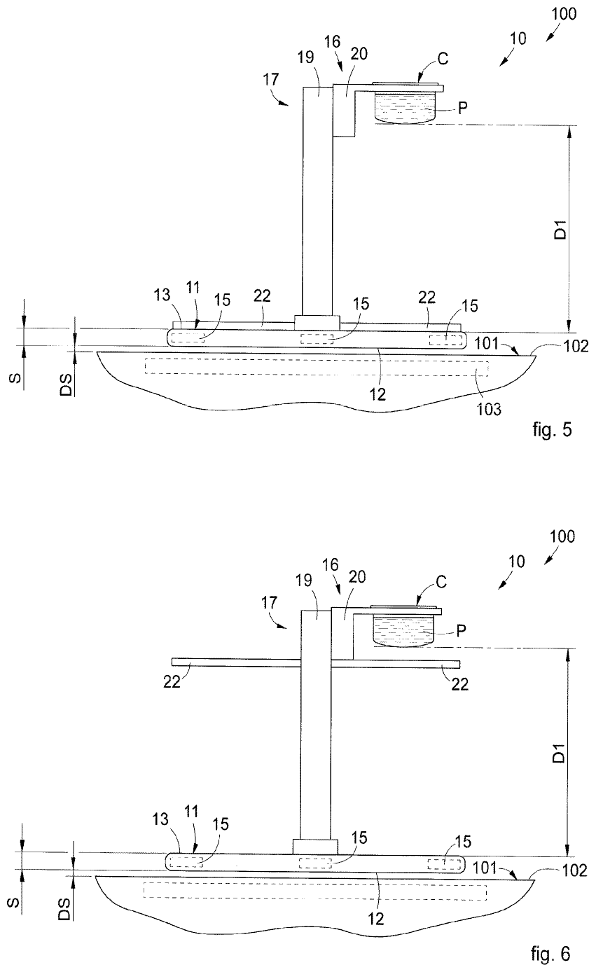

In accordance with another aspect of the present invention, the moving device 10 is provided with one or more shielding elements 22 (FIGS. 5 and 6) placed between the upper surface 13 and the objects C, and configured to limit and/or diminish the effect of the aforementioned electromagnetic phenomena, that is, caused by the interaction between the electric energizing means 103 and the magnetic means 15.

In particular, the shielding elements 22 are made of a metal material with high magnetic permeability, therefore composed predominantly of Nickel and Iron.

The shielding elements 22 are directly associated with the upper surface 13 so as to cooperate with it (FIG. 5). Alternatively, the shielding elements 22 are directly associated with the support member 16 so as to cooperate with it. Specifically, the shielding elements 22 are attached to the base member 17 in such a position as to shield the objects C (FIG. 6).

To better understand the present invention, and as evidence of the values indicated for the minimum distance D1, below are two tables of values relating to the magnetic fields generated for the movement of the moving device 10 and measured with a certain measuring instrument positioned at a certain distance from the driving surface 102.

Specifically, the first table (Table 1) refers to the low-frequency magnetic fields generated by the base plane 101, and the second table (Table 2) refers to the static magnetic field generated by the same moving device 10.

The first table (Table 1) shows the values measured by positioning the measuring instrument at 45 mm from the driving surface 102 and considering a raising distance DS of 4 mm. In this case, the thickness of the transport member 11 is approximately 10 mm.

TABLE 1

| | Value | Exposure | |
|---|---|---|---|
| | measured | level | Absorption |
| Configuration | [mT] | (%) | [W] |
| 1st Configuration | 0.53 | 6.36 | 50 |
| 2nd Configuration | 0.38 | 5.10 | 60 |
| 3rd Configuration | 1.63 | 28.48 | 130 |
| 4th Configuration | 1.84 | 28.26 | 170 |

wherein
the “1st Configuration” refers to a single moving device 10;
the “2nd Configuration” refers to two moving devices 10 placed next to each other;
the “3rd Configuration” refers to three moving devices 10 placed next to each other;
the “4th Configuration” refers to four moving devices 10 placed next to each other;
the “value measured” is expressed in microtesla;
the “exposure level” is expressed as a percentage and refers to the so-called “exposure index”, which represents the exposure to electromagnetic waves detected and divided by the limit value of exposure to them; and
the “absorption” is expressed in Watts, and by this term we mean the absorption of electric current of the electric energizing means 103 that generate the magnetic fields and that interact with the magnetic means 15, allowing the latter to rise from the base plane 101 and to move on it.

In particular, as can be seen in Table 1, the exposure levels are much lower than 100%, therefore the exposure complies with the standards defined by the ICNIRP (International Commission on Non-Ionizing Radiation Protection) and implemented in Italy by the European Council Recommendation n. 1999/519/EC of 12/07/99. Therefore, considering the detection point at 45 mm from the driving surface 102, the thickness S of the transport member 11 of 10 mm, and the raising distance of 1 mm, the minimum distance D1=45−10−4=31 mm.

The second table (Table 2) shows the values measured by positioning the measuring instrument at different distances from the driving surface 102, with the raising distance DS equal to 4 mm, and in a condition in which the indirect effects related to magnetic induction are also considered. Also in this case, the thickness S of the transport member 11 is of approximately 10 mm.

TABLE 2

| | | | Action values |
|---|---|---|---|
| | Value | Exposure | Indirect effects related |
| | measured | level | to magnetic induction |
| Configuration | [mT] | (%) | [%] |
| 1st Configuration | 3.11 | 0.78 | 622 |
| 2nd Configuration | 0.73 | 0.18 | 146 |
| 3rd Configuration | 0.15 | 0.04 | 29 |

wherein:
in the “1st Configuration” the measuring device is positioned at 45 mm from the driving surface 102;
in the “2nd Configuration” the measuring device is positioned at 75 mm from the driving surface 102;
in the “3rd Configuration” the measuring device is positioned at 135 mm from the driving surface 102; and
the “Action values” relating to the indirect effects related to magnetic induction are expressed as a percentage and calculated in a similar manner to the values of the “Exposure Level”.

As can be seen in the second table, only the “3rd Configuration” has action values relating to the indirect effects related to magnetic induction lower than 100%, and is therefore the only one that complies with the standards provided for by current regulations on the matter. Taking into account these regulations, a limit of the “value measured” equal to 0.5 mT was also considered, which is in any case respected by the “3rd Configuration”.

Therefore, considering the detection point at 135 mm from the driving surface 102, the thickness of the transport member 11 of 10 mm, and the raising distance of 4 mm, the minimum distance D1=135−10−4=121 mm.

It is clear that modifications and/or additions of parts may be made to the moving device 10 as described heretofore, without departing from the field and scope of the present invention, as defined by the claims.

It is also clear that, although the present invention has been described with reference to some specific examples, a person of skill in the art will be able to achieve other equivalent forms of object moving devices, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Moving device for moving objects filled with a product on a base plane having a driving surface and provided with electric energizing means configured to selectively generate one or more magnetic fields, said moving device comprising a transport member provided with magnetic means configured to generate a respective magnetic field capable of interacting with the magnetic fields of said electric energizing means to cause said transport member to contactless slide on said driving surface, and a support member configured to support said objects when the transport member slides on the driving surface, wherein it further comprises one or more shielding elements placed on said moving device in such a manner as to be positioned interposed between an upper surface of said transport member and said objects, when these are supported by said support member, said one or more shielding elements being configured to limit and/or diminish the effect of electromagnetic phenomena caused by the interaction between the electric energizing means and the magnetic means.

2. Moving device as in claim 1, wherein said support member comprises at least one base member placed on said upper surface and having a supporting portion departing from said base member, and a housing portion provided with one or more housing seatings configured to accommodate said objects in a raised position.

3. Moving device as in claim 2, wherein said supporting portion is slidingly mounted on said at least one base member so as to vary the distance from said upper surface.

4. Moving device as in claim 1, wherein said one or more shielding elements are made of a metal material with high magnetic permeability.

5. Moving device as in claim 1, wherein said one or more shielding elements are directly associated with said upper surface or, alternatively, said one or more shielding elements are directly associated with said support member.

6. Apparatus comprising a base plane provided with a driving surface which is provided with electric energizing means configured to selectively generate one or more magnetic fields, a work chamber housing said base plane and in which air flows are generated, wherein it comprises one or more moving devices as in claim 1, which are operatively associated with said base plane and are mobile in said work chamber.
